(19) United States
(12) Patent Application Publication
(10) Pub. No.: US 2005/0175740 A1
(43) Pub. Date: Aug. 11, 2005

(54) Peanut butter pastry product

(76) Inventors: Susan Kay Hall McWatters, Fayetteville, GA (US); Sandra L. Walker, Griffin, GA (US); Sue Ellen McCullough, Griffin, GA (US); Robert Dixon Phillips, Griffin, GA (US); Manjeet S. Chinnan, Riverdale, GA (US)

Correspondence Address: ICE MILLER, ONE AMERICAN SQUARE, BOX 82001, INDIANAPOLIS, IN, 46282, US

(21) Appl. No.: 11/050,555

(22) Filed: Feb. 3, 2005

Related U.S. Application Data
(60) Provisional application No. 60/542,200, filed on Feb. 5, 2004.

(51) Int. Cl. A23G 3/00

(52) U.S. Cl. 426/94

(57) ABSTRACT

Methods and compositions are provided for a nut butter-filled pastry comprising a pastry exterior, and a filling substantially enclosed in the pastry exterior, the filling comprising a nut butter. In illustrative embodiments, the nut butter is peanut butter.

This application claims priority to U.S. Provisional Application No. 60/542,200, filed Feb. 4, 2004, which is herein incorporated by reference in its entirety.

### BACKGROUND AND SUMMARY OF THE INVENTION

Breakfast is considered by nutritionists to be important for learning and performance, especially for young children, but food preparation time in the mornings is often limited. The number of people eating breakfast in the car or in the office is continuing to grow, and portable hand-held foods have become one of the fastest growing segments of the food industry (Sloan, A. E. (1998) Food industry forecast: Consumer trends to 2020 and beyond. Food Technology, 52 (1), 37-44). Most Americans eat some form of breakfast, usually at home, with the most important criteria being no—or very limited—preparation (Sloan, A. E. (2001) Top 10 trends to watch and work on. 3^{rd} biannual report. Food Technology, 55 (4) 38-58). While both carbohydrates and proteins are important energy sources at the start of the day, high carbohydrate breakfasts (e.g., doughnuts, toaster pastries, and juice) are metabolized more quickly than a meal comprised of fruit, grains, and protein (e.g., orange juice, toast, eggs). Peanut butter, a good protein source and a favorite food for many children and adults, could play a significant role in delivery of nutrients at the morning meal. An alternative to protein foods that require cooking (eggs, meats) is a pre-prepared baked tart with peanut butter as the filling. The tart could be eaten without any preparation or could be warmed if desired. Illustratively consumed with milk and fruit, a peanut butter tart would provide a convenient, nutritious, high quality protein meal with longer lasting satiety than a high carbohydrate breakfast.

Illustratively formulating, manufacturing, and marketing a food product involves an understanding of the target consumer and may involve testing, questioning, listening, and re-testing (Sprague, M. (1996) Consumer expectations, product development, and the commodity-based food. Cereal Foods World, 41(4), 226). As desired consumers may be used to guide product development, and interaction with consumers may be initiated early and repeated at numerous occasions throughout the development stage (Saguy, I. S. and Moskowitz, H. R. (1999) Integrating the consumer into new product development. Food Technology, 53 (8), 68-73). In developing food products, it is helpful for the food industry to pay attention to the scientific aspects of consumer needs and desires and to the potential for satisfying them through food technology (Karel, M. (2000) Tasks of food technology in the 21^{st} Century. Food Technology, 54 (6), 56-64).

The objectives of the studies used to develop certain embodiments of the present invention were to:
(1) Establish formulation and process conditions for sheeting, cutting, filling, sealing, and baking a peanut butter-filled pastry tart (study 1),
(2) Determine proximate composition, instrumental color, and consumer acceptability of promising peanut butter tart formulations (study 1),
(3) Modify formulation and process conditions for sheeting, cutting, filling, sealing, and baking a peanut butter-filled pastry tart (study 2), and
(4) Determine proximate composition, instrumental color, and consumer acceptability of the modified peanut butter tarts (study 2).

According to one aspect of this invention, a nut butter-filled pastry is provided, comprising a pastry exterior and a filling substantially enclosed in the pastry exterior, the filling comprising a nut butter. In illustrative embodiments, tarts filled with peanut butter (PNTB), peanut butter sweetened with honey (PNTB/HNY), or peanut butter layered with grape jam (PNTB/GRPJ) are provided. These tarts were evaluated early in the development process by adult consumers. Sensory results indicated that all formulations were acceptable. However, the results suggested a softer, sweeter pastry, optionally using less filling to prevent surface cracking of the pastry.

According to further illustrative embodiments of this invention, a slightly different pastry dough is used and tarts filled with peanut butter sweetened with confectioner's sugar (SPNTB), SPNTB layered with grape jam (SPNTB/GRPJ), or SPNTB layered with strawberry jam (SPNTB/STRWBJ) are provided. These tarts were evaluated by teenage consumers. Sensory results indicated that all tarts were similarly acceptable, although tarts filled with SPNT/STRWBJ had slightly higher ratings than tarts filled with SPNTB/GRPJ and SPNTB.

In another aspect of this invention, methods for preparing a nut butter-filled pastry are provided. The methods comprise providing a pastry exterior, the pastry exterior comprising a top layer having a periphery and a bottom layer having a periphery, placing a filling between the top layer and bottom layer, the filling comprising a nut butter, and sealing the filling within the pastry exterior by sealing substantially all of the periphery of the top layer to substantially all of the periphery of the bottom layer. Illustratively, the top layer and bottom layers may be provided as a single piece of pastry, wherein the single piece of pastry is folded to form the top and bottom layers. The unfolded portion of the periphery may be sealed by crimping or by other means. Separate top and bottom layers may also be used. The methods may also comprise the step of baking the pastry, either partially or completely. Optionally, the pastry may be packaged for sale. In illustrative embodiments, the filling includes a layer of peanut butter, and may or may not include a second filling layer.

Other objects and advantages of the invention will be apparent to those skilled in the art from the following detailed description, taken in conjunction with the appended claims.

### BRIEF DESCRIPTION OF THE DRAWINGS

FIG. 1 is a top view of a pastry tart according to one embodiment of the present invention; and

FIG. 2 is a cross-sectional view of the tart of FIG. 1.

### DETAILED DESCRIPTION

As used herein, the term “pastry dough” refers to dough that does not include yeast for leavening. The resultant pastry is illustratively formed using a single pastry formula for both the top and the bottom of the tart. However, it is understood that several different pastry formulae may be layered, or one formula may be used for the top of the pastry, and another may be used for the bottom layer.

As used herein, the term “peanut butter” refers to a product produced from ground roasted peanuts. Illustratively, the peanut butter is ground to a uniform “smooth” consistency, but “chunky” peanut butter may be used as well. Optionally, the peanut butter may be sweetened, illustratively with powdered sugar, honey, or another sweetener. Other nut butters, illustratively almond, walnut, coconut, pecan, or soy butter, may be used in the place of peanut butter. As used herein, the term “nut butter” includes butters of soy, peanut, almond, macadamia, walnut, pecan, coconut, and other nuts.

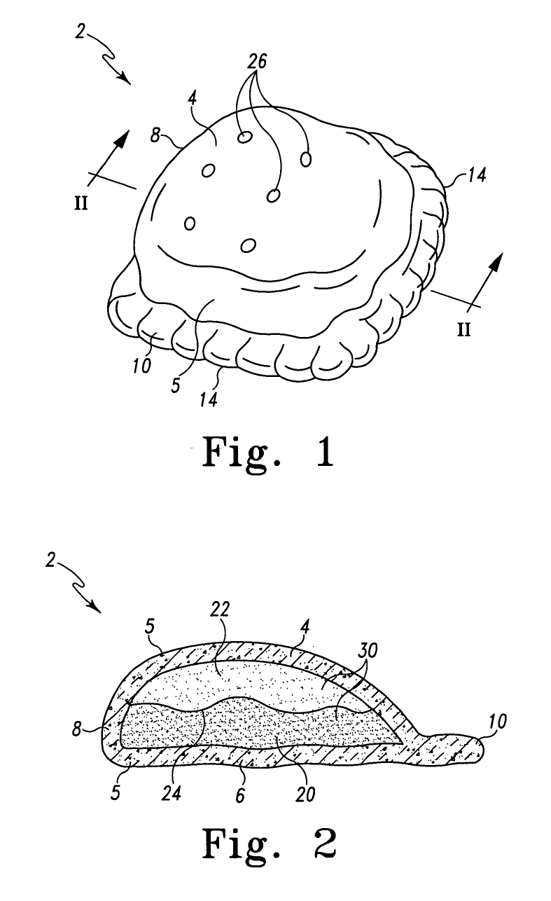

FIGS. 1 and 2 illustrate a pastry tart 2 according to one embodiment of the present invention. As illustrated, tart 2 has a generally semicircular perimeter 14, although it is understood that other shapes may be used within the scope of this invention. As best seen in FIG. 2, tart 2 has a top layer 4 and a bottom layer 6 of pastry, and a filling 30. As shown, filling 30 comprises a peanut butter layer 20 and a second layer 22. While second layer 22 is a fruit filling in many of the examples herein, it is understood that second layer 22 may comprise other ingredients, such as chocolate. Alternatively, second layer 22 may be omitted, so that filling 30 comprises only peanut butter.

Top layer 4 and bottom layer 6 are made from a single layer of pastry dough 5, which has been folded at folded edge 8, and has been crimped together at crimped edge 10, thus generally sealing filling 30 within the pastry dough 5. However, it is understood that top layer 4 and bottom layer 6 could be two separate layers of pastry dough. If two separate layers are used, the layers may be crimped around most of or the entire periphery to seal the filling within the pastry dough. It is desirable to crimp, fold, or otherwise seal substantially all of the periphery of the tart. Prick holes 26 or other openings may be added to allow steam to escape during baking.

Illustratively, the tart 2 is provided in a completely cooked, ready-to-eat form. Because further cooking is not required, the tart need not be flat enough to fit into a conventional vertical toaster. If desired, the tart may be warmed in an oven, a toaster oven, microwave, or by other heating methods. It may be desired, however, to provide the tart in a partially cooked or uncooked form, which could then be further cooked prior to consumption.

Materials and Methods (Studies 1 and 2)

The ingredients used for making tarts were purchased at a local supermarket. Dough ingredients included Pillsbury® bread flour, wheat flour (plain, all purpose), Crisco® all vegetable hydrogenated shortening, Karo® light corn syrup, sugar (granulated, cane), whole milk, whole fresh egg, baking powder, and Morton® iodized salt. Filling ingredients included Kroger® creamy peanut butter, Planters® peanut oil, Kroger® pure clover honey, confectioner's sugar, Smucker's® Concord grape jam, and strawberry jam.

Tart Formulation, Preparation, and Fillings Study 1

Preliminary trials were conducted to formulate the pastry tart. Table 1 shows the ingredient composition used to make pastry tart dough that demonstrated good handling in sheeting and cutting. Trials were also conducted to determine an appropriate amount of filling; 8 grams of Kroger® creamy peanut butter mixed with 5% Planters® peanut oil (PNTB) was found to be suitable. Tarts were filled either with PNTB; PNTB sweetened with 20% Kroger pure clover honey (PNTB/HNY), or 50% PNTB layered with 50% Smucker's® Concord grape jam (PNTB/GRPJ). The grape jam had been dehydrated for 21 hours to 16.2% moisture content in a Nesco® food dehydrator (model FD-27W, Metal Ware Corp., Two Rivers, Wis.). The pastry was prepared by creaming the shortening and sugar together with a handheld mixer (model 2486, Sunbeam-Oster Household Products, Hattiesburg, Miss.) operated on speed 1 for 40 sec. The corn syrup and water were added and mixed on speed 1 for 30 sec and then on speed 2 for 30 sec. The salt was added to the flour and the flour mixture was added to the creamed mixture and mixed on speed 1 for 30 sec. The bowl and beaters were scraped and mixing continued on speed 1 for 30 sec. The mixture was then mixed on speed 2 for 10-20 sec until a soft dough formed. The dough was then kneaded by hand 10 times, divided into balls, and rolled on a lightly floured surface to a uniform thickness of 1.6 mm. The rolled dough was placed on a manually operated turnover machine (model SPM-45, Somerset Industries, North Billerica, Mass.) and the filling for two tarts added. The turnover machine folded, crimped, trimmed, and sealed two tarts in one operation. The tarts were placed on baking sheets, pricked, and then baked in a convection oven (KitchenAid, Benton Harbor, Mich.) at 177° C. for 12 min. Tarts were cooled on racks for 45 min and stored in moisture-vapor-proof plastic containers. While the tarts varied slightly in size, average measurements are approximately 71.7 mm (2.8 inches) in length and 66.8 mm (2.6 inches) in width, with a thickness of about 17.4 mm (0.7 inches). It is understood that larger or smaller tarts could be provided within the scope of this invention.

TABLE 1
Recipe for initial tart dough used in sensory evaluation by adult consumers

| Ingredient | % |
|---|---|
| Wheat Flour (bread) | 50.0 |
| Shortening (hydrogenated vegetable) | 15.0 |
| Water (tap) | 15.0 |
| Corn syrup (light) | 10.0 |
| Sugar (granulated, cane) | 9.5 |
| Salt (iodized) | 0.5 |

Tart Formulation, Preparation, and Fillings Study 2

Comments from the consumer acceptance panel and food service managers/chefs were used to modify the pastry tart ingredients. Numerous formulation trials were conducted to select the formula that demonstrated good handling in sheeting and cutting and produced a softer, sweeter, flakier, and less pasty tart. Table 2 shows the ingredient composition used to make the modified pastry tart dough that had the recommended characteristics. A level of 5% confectioner's sugar was determined to provide adequate but not excessive sweetening of the peanut butter (SPNTB), as well as flavor enhancement. To determine amount of filling, levels of 4, 6, 7, and 8 grams were evaluated. Six grams was found to be an adequate amount to fill the interior of the tart completely, without causing cracking of the pastry and exuding of the filling. However, it is understood that smaller tarts could require less filling and larger tarts could use more. Tarts were filled either with SPNTB; 50% SPNTB layered with 50% Smucker's® Concord grape jam (18.6% moisture content) (SPNTB/GRPJ), or 50% SPNTB layered with 50% dehydrated strawberry jam (14.8% moisture content) (SPNTB/STRWBJ). The pastry was prepared by combining the flour, sugar, salt, and baking powder in a food processor (model 106622F, GE, licensed to Wal-Mart Stores, Bentonville, Ark.) and blending using three 3-sec pulses. The shortening was added and the mixture blended using 4 or 5 3-sec pulses until the mixture resembled coarse cornmeal. With the processor running, slightly beaten eggs that had been stirred together with the milk were added in a steady stream. The processor was turned off. The dough was then kneaded in the processor until a soft dough formed and followed the blade (12-15 pulses). The dough was removed from the processor, kneaded by hand 3-4 times, divided into fist-sized balls, and rolled on a lightly floured surface to a uniform thickness of 1.6 mm. The unused dough was collected, reformed into balls, and re-used no more than three times. Tarts were formed and baked as described in study 1 (baking time was 10 min). Illustratively, the tarts may be packaged for storage at room temperature. A preservative may be added to the dough ingredients, if desired, to improve shelf-life. An illustrative preservative is sodium benzoate. However, it is understood that other preservatives, as are known in the art, may be used. Additionally, while sugar is used in the examples, it is understood that another sweetener may be used as well, particularly if a sugar-free product is desired. Illustrative sweeteners include saccharine, sucralose, and aspartame. It is understood that when an equivalent amount of another sweetener is used instead of sugar, the equivalent amount of sweetness is used, even if this requires a different weight percent of the sweetener.

TABLE 2
Recipe for the modified tart dough used in sensory evaluation by teenage
consumers

| Ingredient | % |
|---|---|
| Wheat Flour (plain, all purpose) | 52.5 |
| Sugar (granulated, cane) | 12.7 |
| Milk (whole) | 11.4 |
| Egg (whole, fresh) | 11.3 |
| Shortening (hydrogenated vegetable) | 11.3 |
| Baking powder | 0.4 |
| Salt (iodized) | 0.4 |

Instrumental Color Studies 1 and 2

A Gardner XL-845 colorimeter (Pacific Scientific, Bethesda, Md.) standardized with a yellow reference tile (L*=82.63, a*=−2.43, b*=29.19) was used to measure the top surface color of individual tarts.

Proximate Analysis Studies 1 and 2

Proximate analysis of the peanut butter tarts included the determination of moisture using 5-g samples dried in a vacuum oven (25 mm Hg) at 70° C. overnight. Crude fat was determined on moisture-free samples using Goldfisch extraction (Labconco, Kansas City, Mo.) with petroleum ether. Nitrogen was determined on 0.5 g samples using the Dumas combustion method (LECO analyzer, model 602-600, Warrendale, Pa.). Factors of 5.70 (wheat) and 5.46 (peanut) were used to convert nitrogen to protein (FAO (1970) Amino Acid Content of Foods and Biological Data on Proteins. Rome: Food and Agriculture Organization of the United Nations). Ash content was determined by heating 0.5 g samples overnight in a muffle furnace at 525° C. Carbohydrate was determined by difference. All proximate analyses were done in triplicate.

Consumer Acceptance Study 1

Untrained panelists (n=73) were recruited from the local community. Criteria for participation were to: (1) be at least 18 years of age, (2) be the primary shopper of the household, (3) eat peanut butter, and (4) be able to eat peanuts, wheat, salt, sugar, and shortening. Table 3 shows the demographic characteristics of the panel. Eighty two percent were white, 75% were females, 62% were married, 61% had household income of <$40,000, 56% were high school graduates, and 45% were employed full-time. Panelists evaluated the appearance, color, aroma, flavor, texture, overall liking, and acceptance of peanut-butter tarts using a 9-point hedonic scale (1=dislike extremely, 9=like extremely). Samples were coded with three-digit random numbers and evaluated under controlled laboratory conditions in partitioned booths illuminated with white incandescent lights. Water and unsalted crackers were provided for panelists to cleanse their palate between samples. Table 4 shows consumers' answers to questions concerning their peanut butter and tart consumption practices, preferences, and willingness-to-buy peanut butter tarts. Two-thirds of the participants ate peanut butter at least once a week; 68% ate peanut butter in a sandwich, and 57% ate it on crackers. Most participants (84%) had eaten breakfast tarts, and 79% indicated they would buy a breakfast tart filled with peanut butter. About three-fourths preferred smooth rather than crunchy peanut butter; 52% preferred no frosting. Two-thirds preferred that peanut butter tarts be served warm rather than at room temperature. Preferred flavors with peanut butter were grape jam (29%), honey (27%), strawberry jam (26%), or peanut butter alone (16%). Seventy-one percent preferred separate (unmixed) layers of peanut butter and fruit jam.

While strawberry and grape jam were used in this study, it is understood that the second layer 22 may include various other fruit products, including dried fruit, jellies, jams, preserves, and conserves, and that fruits other than or in addition to strawberry and grape may be used, illustratively peach. If desired, combinations of two or more fruits may be used. If a fruit filling is used, optionally, the fruit filling may be partially dehydrated, illustratively to a water content of 14-18%. It is believed that partially dehydrating the fruit product to this moisture content minimizes the exchange of water between the peanut butter layer 20 and the fruit filling of second layer 22, and better maintains the boundary 24 between the layers. It is also understood that other fillings that combine well with peanut butter may be used for second layer 22, illustratively chocolate.

Further, it is understood that peanut butter of any consistency may be used within the scope of this invention, including smooth or chunky peanut butter. Also, soy butter may be substituted for peanut butter. This is particularly useful for individuals who suffer from peanut butter allergies. Other nut butters may be used as well, including almond, macadamia, pecan, coconut, and walnut, to replace some or all of the peanut butter.

TABLE 3
Demographic characteristics of adult consumers (n = 73) who
participated in sensory evaluation of initial peanut butter tarts

| Characteristics | Percentage |
|---|---|
| Age | |
| 18-24 yr | 4.1 |
| 25-34 yr | 21.9 |
| 35-44 yr | 15.1 |
| 45-54 yr | 23.3 |
| 55-64 yr | 21.9 |
| 65-74 yr | 11.0 |
| 75 yr or older | 2.7 |
| Gender | |
| Male | 24.7 |
| Female | 75.3 |
| Race | |
| White | 82.2 |
| Black | 15.1 |
| Spanish/Hispanic | 2.7 |
| Marital status | |
| Never married | 15.1 |
| Married | 61.6 |
| Separated/Divorced | 13.7 |
| Widowed | 9.6 |
| Educational level | |
| Completed 9-12 yr of school | 15.1 |
| Completed high school or equivalent | 30.1 |
| Completed vocational school or some college | 26.0 |
| Completed college | 13.7 |
| Completed graduate or professional school | 15.1 |
| Employment status | |
| Employed full-time | 45.2 |
| Employed part-time | 11.0 |
| Unemployed | 20.5 |
| Retired | 23.3 |
| Household income before taxes | |
| <$19,999 | 22.5 |
| $20,000-$29,999 | 18.3 |
| $30,000-$39,999 | 19.7 |
| $40,000-$49,999 | 7.0 |
| $50,000-$59,999 | 9.9 |
| $60,000-$69,999 | 9.9 |
| >$70,000 | 12.7 |

TABLE 4
Peanut butter and tart consumption practices, preferences, and
willingness-to-buy characteristics of adult consumers (n = 73)

| Questions | | Percentage |
|---|---|---|
| 1. | How often do you eat peanut butter? | |
| | More than once a week | 41.1 |
| | Once a week | 24.7 |
| | More than once a month | 9.6 |
| | Once a month | 8.2 |
| | Less than once a month | 16.4 |
| 2. | How do you most often eat peanut butter at home? | |
| | Alone (straight out of jar) | 20.5 |
| | In a sandwich | 68.5 |
| | On a cracker | 57.5 |
| | Other (on toast, bagel or waffle, in cookies and | 23.3 |
| | candies, on apple or banana) | |
| 3. | Have you eaten breakfast tarts (e.g., Pop-Tart ®, | |
| | fruit bar) | |
| | Yes | 83.6 |
| | No | 16.4 |
| 4. | Would you buy a breakfast tart made with peanut butter | |
| | filling? | |
| | Yes | 79.2 |
| | No | 20.8 |
| 5. | What filling would you prefer in a peanut butter tart? | |
| | Just peanut butter | 16.4 |
| | Grape jam and peanut butter | 28.8 |
| | Strawberry jam and peanut butter | 26.0 |
| | Honey and peanut butter | 27.4 |
| | Other (chocolate or Nutella) | 1.4 |
| 6. | Would you prefer that the peanut butter filling in a tart | |
| | be smooth or crunchy? | |
| | Smooth | 76.7 |
| | Crunchy | 23.3 |
| 7. | Would you prefer the peanut butter tart frosted on top? | |
| | Yes | 46.6 |
| | No | 52.1 |
| | Either way | 1.4 |
| 8. | Would you prefer a peanut butter filled tart to be | |
| | served warm or at room temperature? | |
| | Warm | 67.1 |
| | Room temperature | 32.9 |
| 9. | If the filling contains peanut butter and fruit jam, would | |
| | you prefer that they be separate layers or mixed? | |
| | Separate | 71.2 |
| | Mixed | 28.8 |
| 10. | How much would you be willing to pay for a peanut | |
| | butter filled tart compared to a Pop-Tart ®? | |
| | Less | 9.6 |
| | Same | 83.6 |
| | More | 6.8 |

Consumer acceptance study 2 Untrained panelists (n=106) were recruited from Spalding High School, Griffin, Ga. Criteria for participation were to: (1) be under 18 years of age, (2) eat peanut butter, and (3) not be allergic to the tart ingredients (peanuts, wheat, milk, sugar, vegetable shortening, grapes, and strawberries). Table 5 shows the demographic characteristics of the panel. Eighty four percent of the panelists were 10^{th} graders and 16% were 9^{th} graders, 91% were 15-16 years old, 76% were white, and 58% were females. Panelists evaluated the appearance, color, aroma, flavor, texture, and overall liking of peanut butter tarts using a 9-point hedonic scale (1=dislike extremely, 9=like extremely). Samples were coded with three-digit random numbers and were evaluated in classrooms where each panelist used his/her desk as an evaluation station. Bottled water was provided for the participants to cleanse their palate between samples. Table 6 shows consumers' answers to questions concerning their peanut butter and tart consumption practices, preferences, and willingness-to-buy peanut butter tarts. About half of the participants ate peanut butter at least once a week; 82% ate peanut butter in a sandwich and 45% ate it on crackers. Nearly all of the participants (96%) had eaten breakfast tarts, and 70% indicated they would buy a breakfast tart filled with peanut butter to eat as a snack (91%), a breakfast food (60%) or a dessert (24%). Most participants (82%) preferred smooth rather than crunchy peanut butter; 64% preferred frosted tarts. Sixty percent preferred that peanut butter tarts be served warm rather than at room temperature. Preferred flavors with peanut butter were strawberry jam (41%), grape jam (16%), chocolate (15%), or peanut butter alone (15%). Half of the participants preferred separate layers of peanut butter and fruit jam while the other half preferred peanut butter mixed with fruit jam. Fifty three percent indicated that the amount of filling was just right and 39% would like more filling.

TABLE 5
Demographic characteristics of teenage consumers (n = 106) who
participated in sensory evaluation of the modified peanut butter tarts

| Characteristics | Percentage |
|---|---|
| Age | |
| 14 yr | 3.8 |
| 15 yr | 35.8 |
| 16 yr | 55.5 |
| 17 yr | 4.7 |
| Gender | |
| Male | 41.5 |
| Female | 58.5 |
| Race | |
| White | 76.4 |
| Black | 17.9 |
| Spanish/Hispanic | 1.9 |
| Asian | 0.9 |
| Other (Indian/Black, Mulatto, Irish) | 2.8 |
| Educational level | |
| 9^{th} grade | 16.0 |
| 10^{th} grade | 84.0 |

TABLE 6
Peanut butter and tart consumption practices and preferences of
teenage consumers (n = 106) who evaluated the modified
peanut butter tarts

| Questions | | Percentage |
|---|---|---|
| 1. | How often do you eat peanut butter? | |
| | More than once a week | 18.9 |
| | Once a week | 30.2 |
| | More than once a month | 17.9 |
| | Once a month | 14.2 |
| | Less than once a month | 18.9 |
| 2. | How do you most often eat peanut butter at home? | |
| | Alone (straight out of jar) | 26.4 |
| | In a sandwich | 82.1 |
| | On a cracker | 45.3 |
| | Other (celery, muffin, bagel, milkshakes, | 24.5 |
| | cookies, etc.) | |
| 3. | Have you eaten breakfast tarts (e.g., Pop-Tart ®, | |
| | fruit bar) | |
| | Yes | 96.2 |
| | No | 3.8 |
| 4. | Would you buy a breakfast tart made with peanut | |
| | butter filling? | |
| | Yes | 69.8 |
| | No | 30.2 |
| 5. | What filling would you prefer in a peanut butter tart? | |
| | Just peanut butter | 14.9 |
| | Grape jam and peanut butter | 15.8 |
| | Strawberry jam and peanut butter | 40.6 |
| | Honey and peanut butter | 8.9 |
| | Chocolate and peanut butter | 14.9 |
| | Other (apple jam/jelly, peanut butter with nuts) | 5.0 |
| 6. | Would you prefer that the peanut butter filling in a tart | |
| | be smooth or crunchy? | |
| | Smooth | 82.1 |
| | Crunchy | 17.9 |
| 7. | Would you prefer the peanut butter tart frosted on top? | |
| | Yes | 63.8 |
| | No | 36.2 |
| 8. | Would you prefer a peanut butter filled tart to be served | |
| | warm or at room temperature? | |
| | Warm | 60.4 |
| | Room temperature | 39.6 |
| 9. | If the filling contains peanut butter and fruit jam, would | |
| | you prefer that they be separate layers or mixed? | |
| | Separate | 50.0 |
| | Mixed | 50.0 |
| 10. | How would you eat a peanut butter tart? | |
| | As a breakfast food | 60.4 |
| | As a snack food | 90.6 |
| | As a main course | 6.6 |
| | As a dessert | 24.5 |
| 11. | In the tarts you just tasted, was the amount of filling | |
| | Just right | 52.7 |
| | Needs more | 38.7 |
| | Needs less | 8.6 |

Statistical Analysis Studies 1 and 2

All statistical analyses were performed using the Statistical Analysis System (SAS (1996) SAS user's guide: Statistics, version 6.12. SAS Institute, Cary, N.C.), ANOVA, and Fisher's Least Significant Difference (LSD). Means comparison test procedures were performed on proximate analysis, instrumental color, and consumer acceptance data. Analysis included frequencies of demographic characteristics and questions concerning panelists' peanut butter and tart consumption practices, preferences, and willingness-to-buy peanut butter tarts.

Study 1: Evaluation of Initial Peanut Butter Tarts

Proximate Analysis

Table 7 shows the proximate composition and average weight of initial peanut butter tarts. Moisture contents of the tarts ranged from 8.9% to 11.4%. Tarts filled with PNTB/HNY had the lowest moisture content while PNTB/GRPJ had the highest. Peanut butter tarts filled with PNTB/GRPJ had the lowest percentage of crude fat (19.8%), crude protein (8.2%), and ash (1.0%) and the highest amount of carbohydrate (59.6%) compared to the other formulations. Substituting peanut butter with honey (20%) or grape jam (50%) in the filling decreased crude fat, crude protein and ash content and increased carbohydrate content of the tarts because honey and grape jam contain more sugar than peanut butter. Peanut butter tarts had average weights ranging from 22.9 to 25.9 grams with tarts filled with PNTB/GRPJ having the lowest average weight.

TABLE 7
Proximate composition¹ and average weight of initial peanut butter
tarts evaluated by adult consumers

| | | Crude | | | Carbohy- | |
|---|---|---|---|---|---|---|
| | Moisture | Fat | Protein | Ash | drate³ | Weight |
| Filling² | (%) | (%) | (%) | (%) | (%) | (g) |
| PNTB | 10.1 | 25.6 | 11.2 | 1.4 | 51.7 | 23.4 |
| PNTB/HNY | 8.9 | 25.1 | 11.0 | 1.3 | 53.7 | 25.9 |
| PNTB/GRPJ | 11.4 | 19.8 | 8.2 | 1.0 | 59.6 | 22.9 |

¹Wet weight basis. Mean values of triplicate measurements.
²Peanut butter mixed with 5% Planters peanut oil (PNTB); PNTB sweetened with 20% Kroger pure clover honey (PNYB/HNY); 50% PNTB layered with 50% Smucker's Concord grape jam (PNTB/GRPJ).
³Carbohydrate content was determined by difference.

Instrumental Color

Table 8 shows instrumental color measurements of the top surface of initial peanut butter tarts. The top surface color of the three types of tarts was similar in lightness (L*=59.5 to 61.6), redness/greenness (a*=−0.3 to 0.6) and hue angle (80.7 to 86.3). Peanut butter tarts filled with PNTB/HNY had more saturated, intense color (chroma=24.8) and this was due to their greater yellowness (b*=24.8) than those filled with PNTB or PNTB/GRPJ.

TABLE 8
Mean values for instrumental color measurements of top surface of
initial peanut butter tarts evaluated by adult consumers¹

| Filling² | L*³ | a*⁴ | b*⁵ | Chroma⁶ | Hue Angle⁷ |
|---|---|---|---|---|---|
| PNTB | 59.5 | −0.3 | 19.8b | 19.8b | 86.3 |
| PNTB/HNY | 60.8 | 0.6 | 24.8a | 24.8a | 80.7 |
| PNTB/GRPJ | 61.6 | −0.3 | 19.9b | 19.9b | 86.1 |
| LSD | 3.3 | 1.4 | 2.8 | 2.9 | 12.0 |

¹Mean values in a column not followed by the same letter are significantly different at P ≦ 0.05.
²Peanut butter mixed with 5% Planters peanut oil (PNTB); PNTB sweetened with 20% Kroger pure clover honey (PNYB/HNY); 50% PNTB layered with 50% Smucker's Concord grape jam (PNTB/GRPJ).
³L* = lightness (0 = black, 100 = white),
⁴+a* = redness, −a* = greenness.
⁵+b* = yellowness, −b* = blueness.
⁶chroma = (a*² + b*²)^{1/2}.
⁷hue angle = tan⁻¹(b*/a*).

Acceptability of Peanut Butter Tarts

Table 9 shows mean ratings for sensory quality and acceptability of initial peanut butter tarts evaluated by adult consumers (n=73). Sensory results showed there was no significant difference among the three types of peanut butter tarts in appearance (ratings of 7.0 to 7.1), color (6.8 to 7.0) and aroma (ratings of 6.2 to 6.4). Tarts filled with PNTB/GRPJ received significantly higher ratings for flavor (6.5), texture (6.7), and overall liking (6.6) than tarts filled with PNTB and PNTB/HNY (5.7-5.9, 5.4-6.1, 5.5-5.9 for flavor, texture and overall liking, respectively). Tarts filled with PNTB had the lowest rating for texture and were significantly different from the other tarts. The largest number of consumers (84.5%) considered tarts filled with PNTB/GRPJ the most acceptable (1.15). However, most participants commented that the pastry needed to be softer and sweeter and suggested using less filling to prevent surface cracking of the pastry.

TABLE 9
Mean ratings for sensory quality and acceptability of the initial peanut butter tarts
evaluated by adult consumers¹

| | Sensory Attributes³ | | | | | | | |
|---|---|---|---|---|---|---|---|---|
| | | | | | | Overall | | % Yes |
| Filling² | Appearance | Color | Aroma | Flavor | Texture | liking | Acceptable⁴ | Responses⁵ |
| PNTB | 7.0 | 7.0 | 6.2 | 5.7b | 5.4c | 5.5b | 1.41a | 58.8 |
| PNTB/HNY | 7.1 | 6.8 | 6.3 | 5.9b | 6.1b | 5.9b | 1.33a | 66.7 |
| PNTB/GRPJ | 7.0 | 7.0 | 6.4 | 6.5a | 6.7a | 6.6a | 1.15b | 84.5 |
| LSD | 0.5 | 0.5 | 0.5 | 0.6 | 0.6 | 0.6 | 0.15 | |

¹Mean values in a column not followed by the same letter are significantly different at P ≦ 0.05.
²Peanut butter mixed with 5% Planters peanut oil (PNTB); PNTB sweetened with 20% Kroger pure clover honey (PNYB/HNY); 50% PNTB layered with 50% Smucker's Concord grape jam (PNTB/GRPJ).
³On a 9-point scale, 1 = dislike extremely, 5 = neither like nor dislike, and 9 = like extremely.
⁴1 = Yes, 2 = No.
⁵Percentage of participants who considered the sample to be acceptable.

Eight food service managers/chefs also evaluated the peanut butter tart formulations and indicated that the pastry needed to be shorter, flakier, and less pasty. Additionally, the Quality Assurance Manager for the manufacturer of the peanut butter used in the original fillings suggested that sweetened peanut butter would be more appropriate than plain peanut butter for this application. Results were used to modify pastry formulation, fillings, and amount of filling.

Study 2: Evaluation of Modified Peanut Butter Tarts

Proximate Analysis

Table 10 shows the proximate composition and average weights of the modified peanut butter tarts. Moisture contents of the tarts ranged from 6.5% to 11.5%. Substituting 50% of the peanut butter in the tart filling with grape or strawberry jam decreased crude fat (17.2-18.4%), crude protein (8.7-9.1%) and ash (0.7-0.8%) content of the tarts and increased moisture (9.9-11.5%) and carbohydrate (61.8-61.9%) content since jam contained more sugar and water compared to peanut butter. Peanut butter tarts had an average weight range from 19.2 to 20.2 g. Peanut butter tarts filled with SPNTB/STRWBJ had the highest average weight (20.2 g) and the lowest moisture content (9.9%) because strawberry jam had lower water content (14.8%) than grape jam (18.6%).

TABLE 10
Proximate composition¹ and average weight of the modified peanut
butter tarts evaluated by teenage consumers

| | | Crude | | | Carbohy- | |
|---|---|---|---|---|---|---|
| | Moisture | Fat | Protein | Ash | drate³ | Weight⁴ |
| Filling² | (%) | (%) | (%) | (%) | (%) | (g) |
| SPNTB | 6.5 | 25.2 | 12.1 | 1.3 | 54.9 | 19.4 |
| SPNTB/ | 11.5 | 17.2 | 8.7 | 0.8 | 61.8 | 19.2 |
| GRPJ | | | | | | |
| SPNTB/ | 9.9 | 18.4 | 9.1 | 0.7 | 61.9 | 20.2 |
| STRWBJ | | | | | | |

¹Wet weight basis. Mean values of triplicate measurements.
²Peanut butter mixed with 5% confectioner's sugar (SPNTB); SPNTB layered with 50% Smucker's Concord grape jam (PNTB/GRPJ); SPNTB layered with 50% strawberry jam (SPNTB/STRWBJ).
³Carbohydrate content was determined by difference.
⁴Average of 18-20 individual tarts.

Instrumental Color

Table 11 shows instrumental color measurements of the top surface of modified peanut butter tarts. The top surface color of the three types of tarts was similar in greenness (a*=−1.3 to −1.7), yellowness (b*=20.8 to 21.4), saturated/intense color (chroma=20.8 to 21.4) and hue angle (93.7 to 94.8). Peanut butter tarts filled with SPNTB/STRWBJ had significantly lighter color (L*=70.9) compared to those filled with SPNTB and SPNTB/GRPJ (L*=68.2 and 67.8, respectively).

TABLE 11
Mean values for instrumental color measurements of top surface of
the modified peanut butter tarts evaluated by teenage consumers¹

| Filling² | L*³ | a*⁴ | b*⁵ | Chroma⁶ | Hue Angle⁷ |
|---|---|---|---|---|---|
| SPNTB | 68.2b | −1.4 | 21.4 | 21.4 | 93.7 |
| SPNTB/GRPJ | 67.8b | −1.7 | 21.0 | 21.1 | 94.8 |
| SPNTB/STRWBJ | 70.9a | −1.3 | 20.8 | 20.8 | 93.7 |
| LSD | 2.0 | 0.7 | 1.1 | 1.1 | 2.0 |

¹Mean values in a column not followed by the same letter are significantly different at P < 0.05.
²Peanut butter mixed with 5% confectioner's sugar (SPNTB); SPNTB layered with 50% Smucker's Concord grape jam (PNTB/GRPJ); SPNTB layered with 50% strawberry jam (SPNTB/STRWBJ).
³L* = lightness (0 = black, 100 = white).
⁴+a* = redness, −a* = greenness.
⁵+b* = yellowness, −b* = blueness.
⁶chroma = (a*² + b*²)^{1/2}.
⁷hue angle = tan⁻¹(b*/a*).

Acceptability of Peanut Butter Tarts

Table 12 shows mean ratings for sensory quality and overall liking of modified peanut butter tarts evaluated by teenage consumers (n=106). Sensory results showed that all tarts were similar although tarts filled with SPNT/STRWBJ had slightly higher ratings than those filled with SPNTB/GRPJ and SPNTB. There was no significant difference among the three types of peanut butter tarts in appearance (ratings of 6.4 to 6.5), color (6.0 to 6.2), aroma (ratings of 5.5 to 5.7), flavor (ratings 6.2 to 6.6), texture (ratings 5.7 to 6.2) and overall liking (ratings 6.1 to 6.6).

TABLE 12
Mean ratings for sensory attributes and overall liking of the modified
peanut butter tarts evaluated by teenage consumers¹

| | Sensory Attributes³ | | | | | |
|---|---|---|---|---|---|---|
| | | | | | | Overall |
| Filling² | Appearance | Color | Aroma | Flavor | Texture | Liking |
| SPNTB | 6.4 | 6.0 | 5.6 | 6.2 | 5.7 | 6.1 |
| SPNTB/ | 6.4 | 6.1 | 5.5 | 6.2 | 6.1 | 6.4 |
| GRPJ | | | | | | |
| SPNTB/ | 6.5 | 6.2 | 5.7 | 6.6 | 6.2 | 6.6 |
| STRWBJ | | | | | | |
| LSD | 0.4 | 0.4 | 0.5 | 0.5 | 0.5 | 0.5 |

¹Mean values in a colunm not followed by the same letter are significantly different at P < 0.05.
²Peanut butter mixed with 5% confectioner's sugar (SPNTB); SPNTB layered with 50% Smucker's Concord grape jam (PNTB/GRPJ); SPNTB layered with 50% strawberry jam (SPNTB/STRWBJ).
³On a 9-point scale, 1 = dislike extremely, 5 = neither like nor dislike, and 9 = like extremely.

All references are herein incorporated by reference in their entireties.

The foregoing detailed description is given for clearness of understanding only, and no unnecessary limitations should be understood therefrom, as modifications within the scope of the invention will be apparent to those skilled in the art.

1. A nut butter-filled pastry comprising
a pastry exterior, and
a filling substantially enclosed in the pastry exterior, the filling comprising a nut butter.

2. The pastry of claim 1, wherein the nut butter is selected from the group consisting of soy butter, peanut butter, almond butter, macadamia butter, walnut butter, coconut butter, and pecan butter.

3. The pastry of claim 2, wherein the nut butter is peanut butter.

4. The pastry of claim 1, wherein the filling further comprises a fruit product.

5. The pastry of claim 4, wherein the fruit product is a jam selected from the group consisting of grape jam, peach jam, and strawberry jam.

6. The pastry of claim 4, wherein the fruit product is partially dehydrated.

7. The pastry of claim 6, wherein the fruit product is a jam having about 14% to about 18% moisture.

8. The pastry of claim 1, wherein the filling further comprises chocolate.

9. The pastry of claim 1, wherein the filling does not comprise a fruit product.

10. The pastry of claim 1, wherein the pastry exterior comprises a top layer and a bottom layer, each having a periphery,
wherein the top layer and bottom layer are sealed to each other around the entire periphery.

11. The pastry of claim 10, wherein the top layer and bottom layer are formed from dough of a single pastry formula.

12. The pastry of claim 11, wherein the top layer and bottom layer are formed from a single piece of dough that is folded to form a first portion of the periphery comprising a folded edge, and crimped together to form a second portion of the periphery comprising a crimped edge.

13. The pastry of claim 1, wherein the pastry exterior is formed from a dough comprising
48-54% flour,
10-17% shortening or butter,
9-15% sugar or the equivalent amount of a non-sugar sweetener,
0.3-0.6% salt.

14. The pastry of claim 13, further comprising
a liquid selected from the group consisting of water or milk.

15. The pastry of claim 13, further comprising at least one additional ingredient selected from the group consisting of corn syrup, egg, and baking powder.

16. The pastry of claim 1, having a moisture content from 6-12%, a crude fat content of 16.5-26%, a protein content of 8-13%, an ash content of less than 2%, a carbohydrate content of 54-63%, and a weight of 15-26 g.

17. A method for preparing a nut butter-filled pastry comprising the steps of
providing a pastry exterior, the pastry exterior comprising a top layer having a periphery and a bottom layer having a periphery,
placing a filling between the top layer and bottom layer, the filling comprising a nut butter, and
sealing the filling within the pastry exterior by sealing substantially all of the periphery of the top layer to substantially all of the periphery of the bottom layer.

18. The method of claim 17, wherein the top layer and bottom layer are provided as a single piece of pastry, the method further comprising the step of folding the single piece of pastry to form the top and bottom layers.

19. The method of claim 17, wherein the sealing step comprises crimping at least a portion of the periphery of the top layer to at least a portion of the periphery of the bottom layer.

20. The method of claim 17, further comprising the step of baking the pastry.
